(19) United States
(12) Patent Application Publication
(10) Pub. No.: US 2025/0079073 A1
(43) Pub. Date: Mar. 6, 2025

(54) RESONANT INDUCTOR INTEGRATED TRANSFORMER MODULE

(71) Applicant: Atum Co., Ltd., Ansan-si (KR)

(72) Inventor: Taeksoo HAN, Seoul (KR)

(21) Appl. No.: 18/817,227

(22) Filed: Aug. 28, 2024

(30) Foreign Application Priority Data
Sep. 5, 2023 (KR) 10-2023-0117928

(51) Int. Cl. H01F 27/29; B60L 53/22; H01F 27/02; H01F 27/24

(52) U.S. Cl. CPC H01F 27/29; H01F 27/02; H01F 27/24; B60L 53/22

(57) ABSTRACT

The present disclosure relates to a resonant inductor integrated transformer module including: a transformer; and resonant inductors as spiral coils located on one side and the other side of the transformer in such a way as to be connected to primary and secondary coils of the transformer and resonate with the capacitance in the transformer.

### BACKGROUND OF THE DISCLOSURE

### CROSS REFERENCE TO RELATED APPLICATION OF THE DISCLOSURE

The present application claims the benefit of Korean Patent Application No. 10-2023-0117928 filed in the Korean Intellectual Property Office on Sep. 5, 2023, the entire contents of which are incorporated herein by reference.

### FIELD OF THE DISCLOSURE

The present disclosure relates to a transformer, more specifically to a transformer for an on-board charger (OBC) of an electric vehicle.

### BACKGROUND OF THE RELATED ART

A plug-in hybrid electric vehicle (PHEV) and an electric vehicle (EV) (hereinafter, referred to collectively as electric vehicle) are provided with a charger for charging a high-voltage battery that drives the motor of the vehicle with 200V AC, and the charger is called an on-board charger (OBC).

The OBC built in the electric vehicle is configured to have an inductor-inductor-capacitor (LLC) converter, and the LLC converter has a transformer for converting a high-frequency AC voltage into a higher voltage and physically insulating the 220V AC from the high-voltage battery.

However, the transformer and the inductor of the LLC converter of the OBC of the conventional electric vehicle are physically separated from each other, thereby disadvantageously causing the OBC of the electric vehicle to be bulky and increasing the man hour for mounting them on a printed circuit board (PCB).

### SUMMARY OF THE DISCLOSURE

Accordingly, the present disclosure has been made in view of the above-mentioned problems occurring in the related art, and it is an object of the present disclosure to provide a resonant inductor integrated transformer module that is capable of having resonant inductors provided in a transformer itself, so that the resonant inductors have resonance with the capacitance in the transformer itself, thereby providing a transformer, especially a transformer module for an OBC of an electric vehicle that has high efficiency and low heat.

It is another object of the present disclosure to provide a resonant inductor integrated transformer module that is capable of having resonant inductors integral with a transformer, so that a space occupied thereby becomes small, thereby being advantageous in designing circuits in a PCB, and if the circuits are designed to have the resonant inductors integral with the transformer, the number of parts and a size of the PCB are reduced.

It is yet another object of the present disclosure to provide a resonant inductor integrated transformer module that is capable of controlling the reflection characteristics of electromagnetic waves found at zero-crossing points.

It is still another object of the present disclosure to provide a resonant inductor integrated transformer module that is capable of emitting heat generated from a transformer, while the characteristics of the transformer and resonant inductors are being still kept, thereby improving heat emission efficiency of the transformer.

It is yet still another object of the present disclosure to provide a resonant inductor integrated transformer module that is capable of allowing primary and secondary coils of a transformer and resonant inductors to be shielded by magnetic cores, so that perfect resonance is generated, thereby improving the efficiency of the transformer and the temperature characteristics of the transformer.

It is another object of the present disclosure to provide a resonant inductor integrated transformer module that is capable of having a transformer and resonant inductors configured as a single integrated module, thereby being provided as a compact transformer module, especially a compact transformer module for an OBC of an electric vehicle.

To accomplish the above-mentioned objects, according to one aspect of the present disclosure, there is provided a resonant inductor integrated transformer module including: a transformer; and a first resonant inductor and a second resonant inductor as spiral coils located on one side and the other side of the transformer in such a way as to be connected to primary and secondary coils of the transformer and resonate with the capacitance in the transformer.

According to the present disclosure, desirably, the transformer is a transform for an OBC of an electric vehicle.

To accomplish the above-mentioned objects, according to another aspect of the present disclosure, there is provided a resonant inductor integrated transformer module for an OBC of an electric vehicle, including: a transformer; and resonant inductors as spiral coils located on one side and the other side of the transformer in such a way as to be connected to primary and secondary coils of the transformer and resonate with the capacitance in the transformer.

### BRIEF DESCRIPTION OF THE DRAWINGS

The above and other objects, features and advantages of the present disclosure will be apparent from the following detailed description of the preferred embodiments of the disclosure in conjunction with the accompanying drawings, in which:

FIG. 1 is a perspective view showing a resonant inductor integrated transformer module according to the present disclosure;

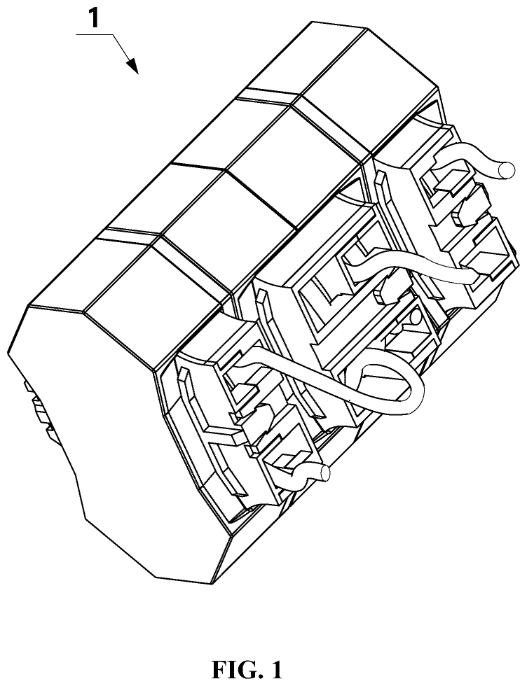

FIG. 2 is a front view showing the resonant inductor integrated transformer module according to the present disclosure;

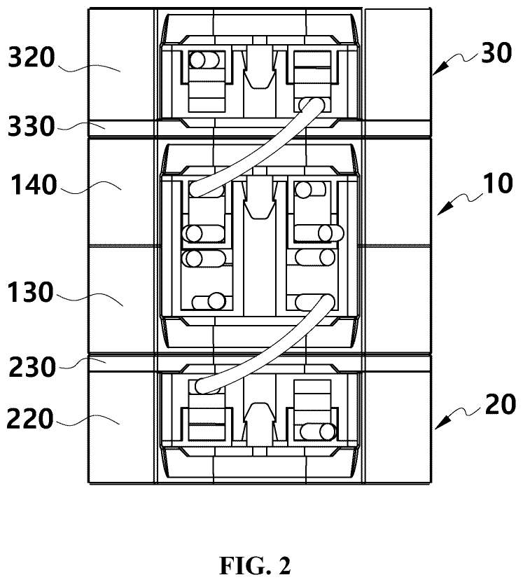

FIG. 3 is a sectional view showing the resonant inductor integrated transformer module according to the present disclosure;

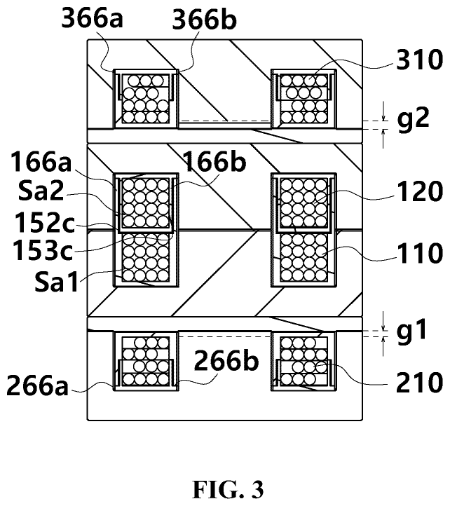

FIG. 4 is a plan view showing the resonant inductor integrated transformer module according to the present disclosure;

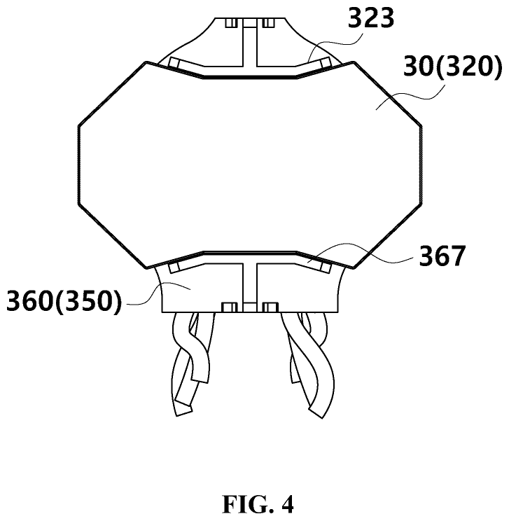

FIG. 5 is an exploded perspective view showing the resonant inductor integrated transformer module according to the present disclosure; and

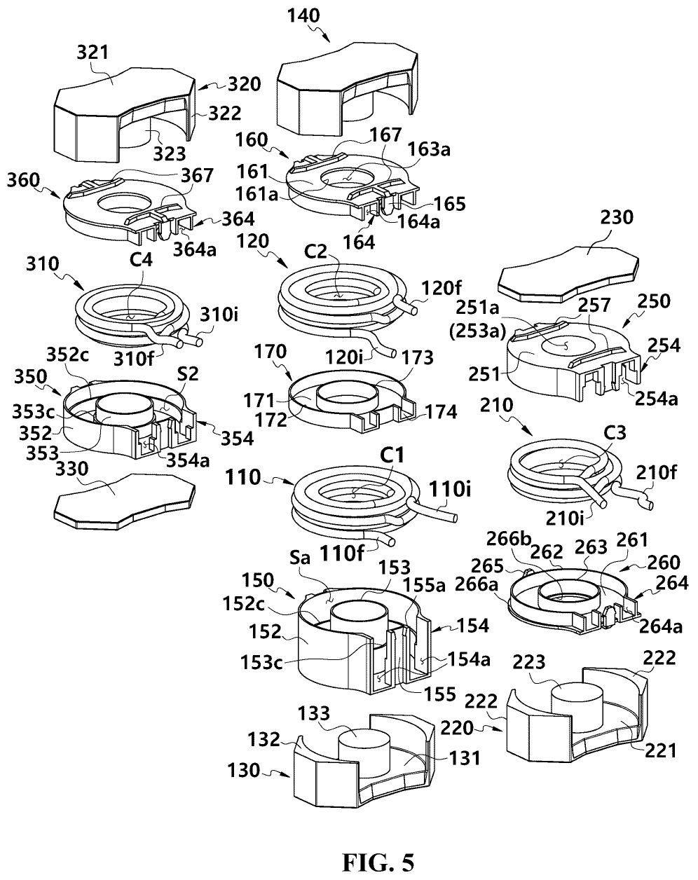

FIG. 6 is an exploded bottom perspective view showing main components of the resonant inductor integrated transformer module according to the present disclosure.

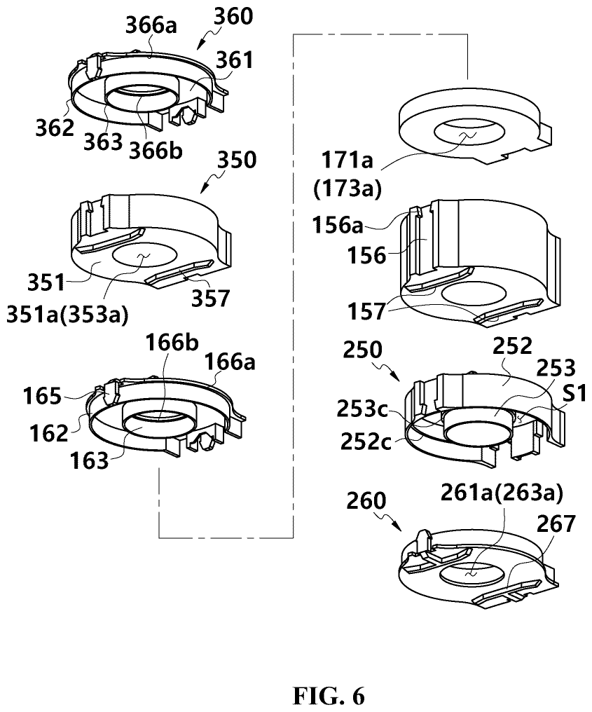

### DETAILED DESCRIPTION OF THE PREFERRED EMBODIMENTS

Hereinafter, an explanation of a resonant inductor integrated transformer module according to an embodiment of the present disclosure will be given in detail with reference to the attached drawings.

A resonant inductor integrated transformer module 1 according to the present disclosure desirably is a resonant inductor integrated transformer module for an on-board charger (OBC) of an electric vehicle.

The resonant inductor integrated transformer module 1 according to the present disclosure includes a transformer 10 and resonant inductors 210 and 310.

The resonant inductors 210 and 310 are spiral coils and located on one side and the other side of the transformer 10 in such a way as to be connected to primary and secondary coils 110 and 120 of the transformer 10 so that the resonant inductors 210 and 310 resonate with the capacitance in the transformer 10 itself.

Further, the resonant inductors 210 and 310 are resonant coils.

As the resonant inductors 210 and 310 are provided in the transformer 10 itself, they resonate with the capacitance stored in the transformer 10 itself.

Furthermore, as the resonant inductors 210 and 310 are integral with the transformer 10, a space occupied thereby becomes small, thereby being advantageous in designing circuits in a PCB, and if the circuits are designed to allow the resonant inductors 210 and 310 to be integral with the transformer 10, the number of parts and a size of the PCB are reduced.

As the resonant inductors 210 and 310 and the transformer 10 are configured as one module, a manufacturing cost of a product is reduced.

The resonant inductor 210 is a first resonant inductor located on one side of the transformer 10, and the resonant inductor 310 is a second resonant inductor located on the other side of the transformer 10.

Further, the resonant inductor integrated transformer module 1 according to the present disclosure includes first resonant magnetic cores 220 and 230 located on the first resonant inductor 210 to increase a magnetic flux density generated by the electric current applied to the first resonant inductor 210 and second resonant magnetic cores 320 and 330 located on the second resonant inductor 310 to increase a magnetic flux density generated by the electric current applied to the second resonant inductor 310.

The reflection characteristics of electromagnetic waves are found at zero-crossing points, and as the first resonant magnetic cores 220 and 230 and the second resonant magnetic cores 320 and 330 are located on the first resonant inductor 210 and the second resonant inductor 310, therefore, such reflection characteristics can be controlled advantageously.

The transformer 10 includes the primary coil 110, the secondary coil 120 whose induced current is generated by the electric current applied to the primary coil 110, a first main magnetic core 130 provided for the primary coil 110 to increase a magnetic flux density generated by an induced current, and a second main magnetic core 140 provided for the secondary coil 120 to increase a magnetic flux density generated by the induced current.

The first resonant magnetic cores 220 and 230 whose inner surfaces (tops in the drawings) facing the transformer 10 are brought into close contact with the outer surface (underside in the drawings) of the first main magnetic core 130.

The second resonant magnetic cores 320 and 330 whose inner surfaces (undersides in the drawings) facing the transformer 10 are brought into close contact with the outer surface (top in the drawings) of the second main magnetic core 140.

As a result, the heat generated from the transformer 10 is emitted, while the characteristics of the transformer 10 and the first and second resonant inductors 210 and 310 are being still kept, thereby improving heat emission efficiency of the transformer 10.

Further, the primary and secondary coils 110 and 120 and the first and second resonant inductors 210 and 310 are shielded by the magnetic cores 130, 140, 220, 230, 320, and 330, and simultaneously, the first and second main magnetic cores 130 and 140 are brought into close contact with the first and second resonant magnetic cores 220, 230, 320, and 330, so that perfect resonance is generated, thereby improving the efficiency of the transformer 10 and achieving excellent temperature characteristics of the transformer 10.

In the case of the resonant inductor integrated transformer module 1 according to the present disclosure, the primary coil 110 is provided by winding a conducting wire in the form of a coil in such a way as to form a first hollow portion C1 at the central portion thereof, and the first resonant inductor 210 is provided by winding a conducting wire extending from an output portion 110f of the primary coil 110 toward an input portion 210i of the first resonant inductor 210 in the form of a coil in such a way as to form a third hollow portion C3 at the central portion thereof, so that the first resonant inductor 210 and the primary coil 110 are connected in series with each other.

In the same manner as above, the secondary coil 120 is provided by winding a conducting wire in the form of a coil in such a way as to form a second hollow portion C2 at the central portion thereof, and the second resonant inductor 310 is provided by winding a conducting wire extending from an output portion 120f of the secondary coil 120 toward an input portion 310i of the second resonant inductor 310 in the form of a coil in such a way as to form a fourth hollow portion C4 at the central portion thereof, so that the second resonant inductor 310 and the secondary coil 120 are connected in series with each other.

The series connection between the first resonant inductor 210 and the primary coil 110 is not made after the respective conducting wires are separately made, but made by forming the output portion 110f of the primary coil 110 and the input portion 210i of the first resonant inductor 210 as a single conducting wire.

In the same manner as above, the series connection between the second resonant inductor 310 and the secondary coil 120 is not made after the respective conducting wires are separately made, but made by forming the output portion 120f of the secondary coil 120 and the input portion 310i of the second resonant inductor 310 as a single conducting wire.

The input portion 210i of the first resonant inductor 210 and the output portion 110f of the primary coil 110 are wound to be arranged in the same direction as each other, and the input portion 310i of the second resonant inductor 310 and the output portion 120f of the secondary coil 120 are wound to be arranged in the same direction as each other.

Like this, the primary coil 110, the secondary coil 120, the first resonant inductor 210, and the second resonant inductor 310 are connected in series with one another as a single assembly, thereby reducing a height and size of the transformer module 1.

Further, a loss between the primary coil 110 and the secondary coil 120 is reduced, thereby enhancing the efficiency of the transformer 10.

The first resonant magnetic core 220 is a first resonant outer core, and the first resonant magnetic core 230 is a first resonant inner core, so that they provide a magnetic circuit (closed magnetic flux), and an air gap g1 is formed between a middle leg 223 of the first resonant outer core 220 and the first resonant inner core 230.

The second resonant magnetic core 320 is a second resonant outer core, and the second resonant magnetic core 330 is a second resonant inner core, so that they provide a magnetic circuit, and an air gap g2 is formed between a middle leg 323 of the second resonant outer core 320 and the second resonant inner core 330.

Like this, the air gaps g1 and g2 are formed between the middle legs 223 and 323 of the first and second resonant outer cores 220 and 320 and the first and second resonant inner cores 230 and 330, thereby allowing perfect resonance to be generated in the resonant inductors 210 and 310.

The first and second resonant outer cores 220 and 320 are rectangular modulus (RM) type cores.

The air gaps g1 and g2 are preferably in the range of 0.9 to 1.3 mm, more preferably in the range of 1.0 to 1.2 mm.

The first resonant inner core 230 whose outer surface (top in the drawings) is brought into close contact with the underside of the first main magnetic core 130.

The second resonant inner core 330 whose outer surface (underside in the drawings) is brought into close contact with top of the second main magnetic core 140.

The first main magnetic core 130 includes a first main base 131 having the shape of a flat plate, first main outer legs 132 protruding from both outer edges of the first main base 131, and a first main middle leg 133 spaced apart from the first main outer legs 132 in such a way as to protrude from a central portion of the first main base 131 and be inserted into the first hollow portion C1 of the primary coil 110.

The second main magnetic core 140 includes a second main base 141 having the shape of a flat plate, second main outer legs 142 protruding from both outer edges of the second main base 141, and a second main middle leg 143 spaced apart from the second main outer legs 142 in such a way as to protrude from a central portion of the second main base 141 and be inserted into the second hollow portion C2 of the secondary coil 120.

The first resonant outer core 220 includes a first resonant base 221 having the shape of a flat plate, first resonant outer legs 222 protruding from both outer edges of the first resonant base 221, and the first resonant middle leg 223 spaced apart from the first resonant outer legs 222 in such a way as to protrude from a central portion of the first resonant base 221 and be inserted into the third hollow portion C3 of the first resonant inductor 210, and the first resonant inner core 230 forms the magnetic circuit (closed magnetic flux), together with the first resonant outer core 220 and has the shape of a flat plate coming into close contact with the first main base 131.

The second resonant outer core 320 includes a second resonant base 321 having the shape of a flat plate, second resonant outer legs 322 protruding from both outer edges of the second resonant base 321, and the second resonant middle leg 323 spaced apart from the second resonant outer legs 322 in such a way as to protrude from a central portion of the second resonant base 321 and be inserted into the fourth hollow portion C4 of the second resonant inductor 310, and the second resonant inner core 330 forms the magnetic circuit (closed magnetic flux), together with the second resonant outer core 320 and has the shape of a flat plate coming into close contact with the second main base 141.

The transformer 10, the first resonant magnetic cores 220 and 230 coming into close contact with the first main magnetic core 130, the first resonant inductor 210 wound inside the first resonant magnetic cores 220 and 230, the second resonant magnetic cores 320 and 330 coming into close contact with the second main magnetic core 140, and the second resonant inductor 310 wound inside the second resonant magnetic cores 320 and 330 are inserted into a casing (not shown) and molded integrally with one another by means of insulating resin.

In the case of the resonant inductor integrated transformer module 1 according to the present disclosure, the transformer 10 is a transformer for the OBC of the electric vehicle.

Further, the resonant inductor integrated transformer module 1 according to the present disclosure includes a main housing 150, a main cover 160, an inner mount 170, a first housing 250, a first cover 260, a second housing 350, and a second cover 360.

The main housing 150, which is made of a synthetic resin, is inserted into a space between the middle legs 133 and 143 and the outer legs 132 and 142 of the first and second main magnetic cores 130 and 140, while having a main insertion space Sa formed therein to insert the primary coil 110 and the secondary coil 120 thereinto.

The main cover 160, which is made of a synthetic resin, is fastened to the main housing 150 in such a way as to open and close the main insertion space Sa of the main housing 150.

The inner mount 170, which is made of a synthetic resin, is located in the main insertion space Sa to dividedly partition the primary coil 110 and the secondary coil 120 so that the primary coil 110 and the secondary coil 120 are insulated from each other and the secondary coil 120 is fixed in position.

The first housing 250, which is made of a synthetic resin, is inserted into a space between the middle leg 223 and the outer legs 222 of the first resonant magnetic core 220, while having a first insertion space S1 formed therein to insert the first resonant inductor 210 thereinto.

The first cover 260, which is made of a synthetic resin, is fastened to the first housing 250 in such a way as to open and close the first insertion space S1 of the first housing 250.

The second housing 350, which is made of a synthetic resin, is inserted into a space between the middle leg 323 and the outer legs 322 of the second resonant magnetic core 320, while having a second insertion space S2 formed therein to insert the second resonant inductor 310 thereinto.

The second cover 360, which is made of a synthetic resin, is fastened to the second housing 350 in such a way as to open and close the second insertion space S2 of the second housing 350.

One (primary coil 110 in the drawings) of the primary coil 110 and the secondary coil 120 is placed on a bottom (that is, a main bottom 151) of the main housing 150, and the other (secondary coil 120 in the drawings) on a bottom (that is, an inner plate 171) of the inner mount 170.

The primary coil 110 and the secondary coil 120 are fixed to the main insertion space Sa, without any movements, by means of an inwardly applied force (that is, attractive force or compressive force) between the main housing 150 and the main cover 160.

The first inductor coil 210 is fixed to the first insertion space S1, without any movements, by means of an inwardly applied force (that is, attractive force or compressive force) between the first housing 250 and the first cover 260.

The second inductor coil 310 is fixed to the second insertion space S2, without any movements, by means of an inwardly applied force (that is, attractive force or compressive force) between the second housing 350 and the second cover 360.

As a result, the primary coil 110 and the secondary coil 120 are inserted into the single housing, thereby reducing the height and size of the transformer 10, and the loss between the primary coil 110 and the secondary coil 120 decreases to enhance the efficiency of the transformer 10.

Under such a simple configuration, the insulation between the primary coil 110 and the secondary coil 120 is reliably ensured.

Further, safety distances between the primary and secondary coils 110 and 120 and the magnetic cores 130 and 140 extend, thereby more reliably ensuring the insulation.

Besides, the secondary coil 120 is doubly inserted into the main housing 150 and the inner mount 170, thereby achieving high insulative internal pressure and more extending the safety distance thereof.

According to the embodiment of the present disclosure, as shown, the secondary coil 120 is located above the primary coil 110, but the present disclosure may not be limited thereto. That is, of course, the primary coil 110 may be located on the inner mount 170, and the secondary coil 120 may be located below the primary coil 110, which are within the technical scope of the present disclosure.

The main housing 150 includes the flat main bottom 151 having a main central hole 151a formed thereon, a main outer wall 152 protruding upward from the outer periphery of the main bottom 151, a main support pipe 153 protruding upward from the inner periphery of the main central hole 151a to form the main insertion space Sa between the outer periphery thereof and the main outer wall 152 and having a main through hole 153a communicating with the main central hole 151a, and a main conducting wire guide block 154 having a pair of input and output channels 154a open on top and concaved downward from the open top in such a way as to be spaced apart from each other by a given distance on one side (front surface in the drawings) of the main outer wall 152 so that the main conducting wire guide block 154 serves to stably guide the input and output portions 110i, 110f, 120i, and 120f of the primary coil 110 and the secondary coil 120 through the pair of input and output channels 154a.

The inner mount 170 includes the flat inner bottom 171 having an inner central hole 171a formed thereon, an inner outer wall 172 protruding upward from the outer periphery of the inner bottom 171, and an inner support pipe 173 protruding upward from the inner periphery of the inner central hole 171a to form a seating space between the outer periphery thereof and the inner outer wall 172 and having an inner through hole 173a communicating with the inner central hole 171a.

The main cover 160 includes a flat cover plate 161 having a cover central hole 161a formed thereon, a cover outer wall 162 spaced apart from the outer periphery of the cover plate 161 toward the inner periphery in a radial direction and protruding vertically from the cover plate 161, a cover support pipe 163 protruding vertically from the inner periphery of the cover central hole 161a to form the main insertion space Sa between the outer periphery thereof and the cover outer wall 162 and having a cover through hole 163a communicating with the cover central hole 161a, and a cover conducting wire guide block 164 fitted to the main conducting wire guide block 154 and having a pair of input and output channels 164a open on top and concaved downward from the open top in such a way as to be spaced apart from each other by a given distance on one side (front surface in the drawings) of the cover outer wall 162 so that the cover conducting wire guide block 164 serves to stably guide the input and output portions 110i, 110f, 120i, and 120f of the primary coil 110 and the secondary coil 120 through the pair of input and output channels 164a.

The main housing 150 further includes a first guide channel 155 concaved inwardly in a radial direction from the main outer wall 152 between the pair of input and output channels 154a, a second guide channel 156 concaved inwardly from the main outer wall 152 on the opposite side (the rear surface in the drawings) to the first guide channel 155, a first locking stepped portion 155a protruding inwardly from the first guide channel 155, and a second locking stepped portion 156a protruding inwardly from the second guide channel 156.

The main cover 160 further includes a first hook 165 protruding vertically downward from one side (the front surface in the drawings) thereof in such a way as to be descended along the first guide channel 155 and thus lockedly fastened to the first locking stepped portion 155a and a second hook 166 protruding vertically downward from the other side (the rear surface in the drawings) thereof in such a way as to be descended along the second guide channel 156 and thus lockedly fastened to the second locking stepped portion 156a.

The primary coil 110 and the secondary coil 120, which are inserted into the main insertion space Sa, are compressed by means of the inwardly attractive force (fastening force) between the main housing 150 and the main cover 160, so that the primary coil 110, the inner mount 170, and the secondary coil 120 are firmly located in the main insertion space Sa, without any movements.

As the cover outer wall 162 is spaced apart from the outer periphery of the cover plate 161 toward the inner periphery in the radial direction, the main cover 160 has a cover outer support rib 166a formed along the outer periphery of the cover plate 161 in such a way as to be fitted to the main outer wall 152 to support the main outer wall 152.

As the cover support pipe 163 is spaced apart from the inner periphery of the cover central hole 161a toward the outer periphery in the radial direction, further, the main cover 160 has a cover inner support rib 166b formed along the inner periphery of the cover plate 161 in such a way as to be fitted to the main support pipe 153 to support the main support pipe 153.

The main outer wall 152 has an outer support projection 152c formed on the inner peripheral surface thereof, and the main support pipe 153 has an inner support projection 153c formed on the outer peripheral surface thereof at the same height as the outer support projection 152c.

The inner mount 170 is located in the main housing 150 in a state of being supported against the outer support projection 152c and the inner support projection 153c, simultaneously, while dividing the main insertion space Sa into a lower insertion space Sa1 and an upper lower insertion space Sa2.

In the state where the inner mount 170 is supported against the outer support projection 152c and the inner support projection 153c, the cover outer support rib 166a and the cover inner support rib 166b are supportedly brought into close contact with the main outer wall 152 and the main support pipe 153, and simultaneously, the cover outer wall 162 and the cover support pipe 163 are supportedly brought into close contact with the inner outer wall 172 and the inner support pipe 173. Further, the main outer wall 152 is fitted doubly to the cover outer wall 162 and the inner outer wall 172, and the main support pipe 153 is inserted doubly into the cover support pipe 163 and the inner support pipe 173, so that the main cover 160 and the inner mount 170 are fittedly brought into close contact with the main housing 160.

The inner mount 170 is located firmly in the main insertion space Sa by means of the inwardly attractive force (fastening force) between the main housing 150 and the main cover 160.

Under such a simple configuration, the primary coil 110 and the secondary coil 120 are inserted into the main housing 150, without any movements or gaps, while being reliably insulated from each other. Further, the main cover 160 and the inner mount 170 are stably mounted in the main housing 150.

The first housing 250 includes a flat first bottom 251 having a first central hole 251a formed thereon, a first outer wall 252 protruding vertically from the outer periphery of the first bottom 251 toward the first resonant inductor 210, a first support pipe 253 protruding upward from the inner periphery of the first central hole 251a to form an insertion space Sa between the outer periphery thereof and the first outer wall 252 and having a first through hole 253a communicating with the first central hole 251a, and a first conducting wire guide block 254 having a pair of input and output channels 254a spaced apart from each other by a given distance on the first outer wall 252 so that the first conducting wire guide block 254 serves to stably guide the input and output portions 210i and 210f of the first resonant inductor 210 through the pair of input and output channels 254a.

The first cover 260 includes a flat first cover plate 261 having a first cover central hole 261a formed thereon, a first cover outer wall 262 spaced apart from the outer periphery of the first cover plate 261 toward the inner periphery in a radial direction and protruding vertically from the first cover plate 261, a first cover support pipe 263 protruding vertically from the inner periphery of the first cover central hole 261a to form an insertion space between the outer periphery thereof and the first cover outer wall 262 and having a first cover through hole 263a communicating with the first cover central hole 261a, and a first cover conducting wire guide block 264 fitted to the first conducting wire guide block 254 and having a pair of input and output channels 264a spaced apart from each other by a given distance on the first cover outer wall 262 so that the first cover conducting wire guide block 264 serves to stably guide the input and output portions 210i and 210f of the first resonant inductor 210 through the pair of input and output channels 264a.

As the first cover outer wall 262 is spaced apart from the outer periphery of the first cover plate 261 toward the inner periphery in the radial direction, the first cover 260 has a first cover outer support rib 266a formed along the outer periphery of the first cover plate 261 in such a way as to be fitted to the first outer wall 252 to support the first outer wall 252.

As the first cover support pipe 263 is spaced apart from the inner periphery of the first cover central hole 261a toward the outer periphery in the radial direction, further, the first cover 260 has a first cover inner support rib 266b formed along the inner periphery of the first cover plate 261 in such a way as to be fitted to the first support pipe 253 to support the first support pipe 253.

The first outer wall 252 has an outer support projection 252c formed on the inner peripheral surface thereof, and the first support pipe 253 has an inner support projection 253c formed on the outer peripheral surface thereof.

The first outer wall 252 and the first support pipe 253 are supportedly brought into close contact with the first cover outer support rib 266a and the first cover inner support rib 266b, and simultaneously, the first cover outer wall 262 and the first cover support pipe 263 are supportedly brought into close contact with the outer support projection 252c and the inner support projection 253c, so that the first housing 250 and the first cover 260 are fittedly brought into close contact with each other.

The first resonant inductor 210 is located firmly in the insertion space of the first housing 250 by means of the inwardly attractive force (fastening force) between the first housing 250 and the first cover 260.

The second housing 350 includes a flat second bottom 351 having a second central hole 351a formed thereon, a second outer wall 352 protruding vertically from the outer periphery of the second bottom 351 toward the second resonant inductor 310, a second support pipe 353 protruding upwardly from the inner periphery of the second central hole 351a to form an insertion space Sa between the outer periphery thereof and the second outer wall 352 and having a second through hole 353a communicating with the second central hole 351a, and a second conducting wire guide block 354 having a pair of input and output channels 354a spaced apart from each other by a given distance on the second outer wall 352 so that the second conducting wire guide block 354 serves to stably guide the input and output portions 310i and 310f of the second resonant inductor 310 through the pair of input and output channels 354a.

The second cover 360 includes a flat second cover plate 361 having a second cover central hole 361a formed thereon, a second cover outer wall 362 spaced apart from the outer periphery of the second cover plate 361 toward the inner periphery in a radial direction and protruding vertically from the second cover plate 361, a second cover support pipe 363 protruding vertically from the inner periphery of the second cover central hole 361a to form an insertion space between the outer periphery thereof and the second cover outer wall 362 and having a second cover through hole 363a communicating with the second cover central hole 361a, and a second cover conducting wire guide block 364 fitted to the second conducting wire guide block 354 and having a pair of input and output channels 364a spaced apart from each other by a given distance on the second cover outer wall 362 so that the second cover conducting wire guide block 364 serves to stably guide the input and output portions 310i and 310f of the second resonant inductor 310 through the pair of input and output channels 364a.

As the second cover outer wall 362 is spaced apart from the outer periphery of the second cover plate 361 toward the inner periphery in the radial direction, the second cover 360 has a second cover outer support rib 366a formed along the outer periphery of the second cover plate 361 in such a way as to be fitted to the second outer wall 352 to support the second outer wall 352.

As the second cover support pipe 363 is spaced apart from the inner periphery of the second cover central hole 361a toward the outer periphery in the radial direction, further, the second cover 360 has a second cover inner support rib 366b formed along the inner periphery of the second cover plate 361 in such a way as to be fitted to the second support pipe 353 to support the second support pipe 353.

The second outer wall 352 has an outer support projection 352c formed on the inner peripheral surface thereof, and the second support pipe 353 has an inner support projection 353c formed on the outer peripheral surface thereof.

The second outer wall 352 and the second support pipe 353 are supportedly brought into close contact with the second cover outer support rib 366a and the second cover inner support rib 366b, and simultaneously, the second cover outer wall 362 and the second cover support pipe 363 are supportedly brought into close contact with the outer support projection 352c and the inner support projection 353c, so that the second housing 350 and the second cover 360 are fittedly brought into close contact with each other.

The second resonant inductor 310 is located firmly in the insertion space of the second housing 350 by means of the inwardly attractive force (fastening force) between the second housing 350 and the second cover 360.

Under such a simple configuration, the first resonant inductor 210 and the second resonant inductor 310 are inserted in the first and second housings 250 and 350, without any movements or gaps, and further, they become compact as one module, together with the transformer 10.

According to the embodiment of the present disclosure, the main housing 150 further has a pair of first main movement prevention protrusions 157 protruding from the outer surface of the main bottom 151 in such a way as to hold the first main base 131 of the first main magnetic core 130, so that the first main magnetic core 130 brought into close contact with the main bottom 151 is prevented from moving or having a gap.

Further, the main cover 160 has a pair of second main movement prevention protrusions 167 protruding from the outer surface of the cover plate 161 in such a way as to hold the second main base 141 of the second main magnetic core 140, so that the second main magnetic core 140 brought into close contact with the cover plate 161 is prevented from moving or having a gap.

According to the embodiment of the present disclosure, the first housing 250 has a pair of first inner core movement prevention protrusions 257 protruding from the outer surface of the first plate 251 in such a way as to hold the first resonant inner core 230, so that the first resonant inner core 230 brought into close contact with the first plate 251 is prevented from moving or having a gap.

Further, the first cover 260 has a pair of first outer core movement prevention protrusions 267 protruding from the outer surface of the first cover plate 261 in such a way as to hold the first resonant base 221 of the first resonant outer core 220, so that the first resonant outer core 220 brought into close contact with the first cover plate 261 is prevented from moving or having a gap.

According to the embodiment of the present disclosure, the second housing 350 has a pair of second inner core movement prevention protrusions 357 protruding from the outer surface of the second plate 351 in such a way as to hold the second resonant inner core 330, so that the second resonant inner core 330 brought into close contact with the second plate 351 is prevented from moving or having a gap.

Further, the second cover 360 has a pair of second outer core movement prevention protrusions 367 protruding from the outer surface of the second cover plate 361 in such a way as to hold the second resonant base 321 of the second resonant outer core 320, so that the second resonant outer core 320 brought into close contact with the second cover plate 361 is prevented from moving or having a gap.

As described above, the resonant inductor integrated transformer module according to the present disclosure has the following advantages.

Firstly, the resonant inductors are provided in the transformer itself, so that they resonant with the capacitance in the transformer itself, thereby providing the transformer, especially the transformer module for the OBC of the electric vehicle having high efficiency and low heat.

Secondly, the resonant inductors are integral with the transformer, so that a space occupied thereby becomes small, thereby being advantageous in designing circuits in a PCB, and if the circuits are designed to allow the resonant inductors to be integral with the transformer, the number of parts and a size of the PCB are reduced.

Thirdly, the reflection characteristics of electromagnetic waves, which are found at zero-crossing points, are controlled.

Fourthly, the heat generated from the transformer is emitted, while the characteristics of the transformer and the resonant inductors are being still kept, thereby improving heat emission efficiency of the transformer.

Fifthly, the primary and secondary coils of the transformer and the resonant inductors are shielded by the magnetic cores, so that perfect resonance is generated, thereby improving the efficiency of the transformer and the temperature characteristics of the transformer.

Lastly, the transformer and the resonant inductors are configured as a single integrated module, thereby providing a compact transformer module for the OBC of the electric vehicle.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above teachings. For example, the parts expressed in a singular form may be dispersedly provided, and in the same manner as above, the parts dispersed may be combined with each other.

Accordingly, the present subject matter is not limited to the embodiments described above or depicted in the drawings, and various embodiments and modifications can be made without departing from the scope of the claims below.

What is claimed is:

1. A resonant inductor integrated transformer module comprising:
a transformer (10); and
a first resonant inductor (210) and a second resonant inductor (310) as spiral coils located on one side and the other side of the transformer (10) in such a way as to be connected to primary and secondary coils (110 and 120) of the transformer (10) and resonate with the capacitance in the transformer (10).

2. The resonant inductor integrated transformer module according to claim 1, wherein the first resonant inductor (210) is located on one side of the transformer (10), while the second resonant inductor (310) is located on the other side of the transformer (10), and the first resonant inductor (210) has first resonant magnetic cores (220 and 230) adapted to increase a magnetic flux density generated by the electric current applied thereto, while the second resonant inductor (310) has second resonant magnetic cores (320 and 330) adapted to increase a magnetic flux density generated by the electric current applied thereto.

3. The resonant inductor integrated transformer module according to claim 2, wherein the transformer (10) comprises:
the primary coil (110);
the secondary coil (120) whose induced current is generated by the electric current applied to the primary coil (110);
a first main magnetic core (130) provided for the primary coil (110) to increase a magnetic flux density generated by the induced current; and
a second main magnetic core (140) provided for the secondary coil (120) to increase a magnetic flux density generated by the induced current, and
the first resonant magnetic cores (220 and 230) come into close contact with the outer surface of the first main magnetic core (130), while the second resonant magnetic cores (320 and 330) come into close contact with the outer surface of the second main magnetic core (140).

4. The resonant inductor integrated transformer module according to claim 1, wherein the primary coil (110) is provided by winding a conducting wire in such a way as to form a first hollow portion (C1) at the central portion thereof, and the first resonant inductor (210) is provided by winding a conducting wire extending from an output portion (110f) of the primary coil (110) toward an input portion (210i) thereof in such a way as to form a third hollow portion (C3) at the central portion thereof, so that the first resonant inductor (210) and the primary coil (110) are connected in series with each other, and
the secondary coil (120) is provided by winding a conducting wire in such a way as to form a second hollow portion (C2) at the central portion thereof, and the second resonant inductor (310) is provided by winding a conducting wire extending from an output portion (120f) of the secondary coil (120) toward an input portion (310i) thereof in such a way as to form a fourth hollow portion (C4) at the central portion thereof, so that the second resonant inductor (310) and the secondary coil (120) are connected in series with each other.

5. The resonant inductor integrated transformer module according to claim 3, wherein the first resonant magnetic cores (220 and 230) are a first resonant outer core and a first resonant inner core that provide a magnetic circuit, an air gap (g1) being formed between a middle leg (223) of the first resonant outer core (220) and the first resonant inner core (230), and the second resonant magnetic cores (320 and 330) are a second resonant outer core and a second resonant inner core that provide a magnetic circuit, an air gap (g2) being formed between a middle leg (323) of the second resonant outer core (320) and the second resonant inner core (330), the first resonant inner core (230) whose outer surface coming into close contact with the underside of the first main magnetic core (130), and the second resonant inner core (330) whose outer surface coming into close contact with top of the second main magnetic core (140).

6. The resonant inductor integrated transformer module according to claim 5, wherein the transformer (10), the first resonant magnetic cores (220 and 230) coming into close contact with the first main magnetic core (130), the first resonant inductor (210) wound inside the first resonant magnetic cores (220 and 230), the second resonant magnetic cores (320 and 330) coming into close contact with the second main magnetic core (140), and the second resonant inductor (310) wound inside the second resonant magnetic cores (320 and 330) are inserted into a casing and molded integrally with one another by means of insulating resin.

7. The resonant inductor integrated transformer module according to claim 5, further comprising:
a main housing (150) inserted into a space between middle legs (133 and 143) and outer legs (132 and 142) of the first and second main magnetic cores (130 and 140), while having a main insertion space (Sa) formed therein to insert the primary coil (110) and the secondary coil (120) thereinto;
a main cover (160) fastened to the main housing (150) in such a way as to open and close the main insertion space (Sa) of the main housing (150);
an inner mount (170) located in the main insertion space (Sa) to dividedly partition the primary coil (110) and the secondary coil (120) so that the primary coil (110) and the secondary coil (120) are insulated from each other and the secondary coil (120) is fixed in position;
a first housing (250) inserted into a space between the middle leg (223) and outer legs (222) of the first resonant magnetic core (220), while having a first insertion space (S1) formed therein to insert the first resonant inductor (210) thereinto;
a first cover (260) fastened to the first housing (250) in such a way as to open and close the first insertion space (S1) of the first housing (250);
a second housing (350) inserted into a space between the middle leg (323) and outer legs (322) of the second resonant magnetic core (320), while having a second insertion space (S2) formed therein to insert the second resonant inductor (310) thereinto; and
a second cover (360) fastened to the second housing (350) in such a way as to open and close the second insertion space (S2) of the second housing (350),
wherein one of the primary coil (110) and the secondary coil (120) is placed on a bottom of the main housing (150), while the other is placed on a bottom of the inner mount (170); the primary coil (110) and the secondary coil (120) are fixed to the main insertion space (Sa), without any movements, by means of an inwardly applied force between the main housing (150) and the main cover (160); the first inductor coil (210) is fixed to the first insertion space (S1), without any movements, by means of an inwardly applied force between the first housing (250) and the first cover (260); and the second inductor coil (310) is fixed to the second insertion space (S2), without any movements, by means of an inwardly applied force between the second housing (350) and the second cover (360).

8. The resonant inductor integrated transformer module according to claim 7, wherein the main housing (150) comprises:
a flat main bottom (151) having a main central hole (151a) formed thereon;
a main outer wall (152) protruding upward from the outer periphery of the main bottom (151);
a main support pipe (153) protruding upward from the inner periphery of the main central hole (151a) to form the main insertion space (Sa) between the outer periphery thereof and the main outer wall (152) and having a main through hole (153a) communicating with the main central hole (151a); and
a main conducting wire guide block (154) having a pair of input and output channels (154a) open on top and concaved downward from the open top in such a way as to be spaced apart from each other by a given distance on one side of the main outer wall (152) so that the main conducting wire guide block (154) serves to stably guide the input and output portions (110i, 110f, 120i, and 120f) of the primary coil (110) and the secondary coil (120) through the pair of input and output channels (154a),
the inner mount (170) comprises:
a flat inner bottom (171) having an inner central hole (171a) formed thereon;
an inner outer wall (172) protruding upward from the outer periphery of the inner bottom (171); and
an inner support pipe (173) protruding upward from the inner periphery of the inner central hole (171a) to form a seating space between the outer periphery thereof and the inner outer wall (172) and having an inner through hole (173a) communicating with the inner central hole (171a), and
the main cover (160) comprises:
a flat cover plate (161) having a cover central hole (161a) formed thereon;
a cover outer wall (162) spaced apart from the outer periphery of the cover plate (161) toward the inner periphery in a radial direction and protruding vertically from the cover plate (161);
a cover support pipe (163) protruding vertically from the inner periphery of the cover central hole (161a) to form the main insertion space (Sa) between the outer periphery thereof and the cover outer wall (162) and having a cover through hole (163a) communicating with the cover central hole (161a); and
a cover conducting wire guide block (164) fitted to the main conducting wire guide block (154) and having a pair of input and output channels (164a) open on top and concaved downward from the open top in such a way as to be spaced apart from each other by a given distance on one side of the cover outer wall (162) so that the cover conducting wire guide block (164) serves to stably guide the input and output portions (110i, 110f, 120i, and 120f) of the primary coil (110) and the secondary coil (120) through the pair of input and output channels (164a).

9. The resonant inductor integrated transformer module according to claim 8, wherein the main housing (150) further comprises:
a first guide channel (155) concaved inwardly in a radial direction from the main outer wall (152) between the pair of input and output channels (154a);
a second guide channel (156) concaved inwardly from the main outer wall (152) on the opposite side to the first guide channel (155);
a first locking stepped portion (155a) protruding inwardly from the first guide channel (155); and
a second locking stepped portion (156a) protruding inwardly from the second guide channel (156), and
the main cover (160) further comprises:
a first hook (165) protruding vertically downward from one side of the main cover (160) in such a way as to be descended along the first guide channel (155) and thus lockedly fastened to the first locking stepped portion (155a); and
a second hook (166) protruding vertically downward from the other side of the main cover (160) in such a way as to be descended along the second guide channel (156) and thus lockedly fastened to the second locking stepped portion (156a).

10. The resonant inductor integrated transformer module according to claim 9, wherein as the cover outer wall (162) is spaced apart from the outer periphery of the cover plate (161) toward the inner periphery in the radial direction, the main cover (160) has a cover outer support rib (166a) formed along the outer periphery of the cover plate (161) in such a way as to be fitted to the main outer wall (152) to support the main outer wall (152);
as the cover support pipe (163) is spaced apart from the inner periphery of the cover central hole (161a) toward the outer periphery in the radial direction, the main cover (160) has a cover inner support rib (166b) formed along the inner periphery of the cover plate (161) in such a way as to be fitted to the main support pipe (153) to support the main support pipe (153);
the main outer wall (152) has an outer support projection (152c) formed on the inner peripheral surface thereof, while the main support pipe (153) has an inner support projection (153c) formed on the outer peripheral surface thereof at the same height as the outer support projection (152c);
the inner mount (170) is located in the main housing (150) in a state of being supported against the outer support projection (152c) and the inner support projection (153c), simultaneously, while dividing the main insertion space (Sa) into a lower insertion space (Sa1) and an upper lower insertion space (Sa2);
in the state where the inner mount (170) is supported against the outer support projection (152c) and the inner support projection (153c), the cover outer support rib (166a) and the cover inner support rib (166b) are supportedly brought into close contact with the main outer wall (152) and the main support pipe (153), and simultaneously, the cover outer wall (162) and the cover support pipe (163) are supportedly brought into close contact with the inner outer wall (172) and the inner support pipe (173);
the main outer wall (152) is fitted doubly to the cover outer wall (162) and the inner outer wall (172), while the main support pipe (153) is inserted doubly into the cover support pipe (163) and the inner support pipe (173), so that the main cover (160) and the inner mount (170) are fittedly brought into close contact with the main housing (160); and
the inner mount (170) is located firmly in the main insertion space (Sa) by means of the inwardly attractive force between the main housing (150) and the main cover (160).
